(19) United States
(12) Patent Application Publication
(10) Pub. No.: US 2003/0067364 A1
(43) Pub. Date: Apr. 10, 2003

(54) Waveguide twist

(76) Inventors: Konstantin Beis, Backnang (DE); Uwe Rosenberg, Backnang (DE)

Correspondence Address: Kirschstein, Ottinger, Israel & Schiffmiller, P.C., 489 Fifth Avenue, New York, NY, 10017-6105, US

(21) Appl. No.: 10/246,046

(22) Filed: Sep. 18, 2002

(30) Foreign Application Priority Data
Sep. 19, 2001 (EP) 01122376.5

(51) Int. Cl. H01P 1/165

(52) U.S. Cl. 333/21 A

(57) ABSTRACT

In a waveguide twist which provides orthogonal rotation of both direction and polarisation, TE₁₀—mode energy in waveguide W1 is coupled via iris I1 to a transformer cavity capable of exciting both TE₁₀ and TE₀₁ modes. The TE₀₁ mode is coupled via iris I2 to output waveguide W2. Transformers may be interposed between one or both waveguides and their associated irises to increase bandwidth. The configuration facilitates manufacture in two halves by simple machining or casting.

This invention relates to transition between two orthogonally arranged rectangular waveguide ports. It particularly relates to such a transition where the orientation of the waveguide sections are also orthogonal. Such a transition can be particularly useful in integrated waveguide sub-systems.

So-called waveguide twists are known which allow a coupling between waveguides having different angular orientations. One such type using step twist sections is discussed in “Step-Twist Waveguide Components”—Wheeler H A, IRE Trans. Microwave Theory Tech. Vol. MTT-S pp. 44-52 October 1955. Such transitions utilise series-connected intermediate sections of a rectangular waveguide arranged at progressively greater angles of inclination, Such arrangements are expensive to manufacture and are only suitable for coupling wav-guides whose axes are coincident. Another waveguide twist for coupling between waveguides when axes are parallel but not coincident is disclosed in German published patent DE 3824150 C2.

The invention provides a waveguide twist providing orthogonal rotation of both direction and polarisation, comprising: a transformer section having a generally square cross-section and having a first transformer end face and a side face; a first rectangular waveguide arranged to propagate microwave energy having a first polarisation and whose axis is arranged orthogonal to the first transformer end face with its short side parallel to the side face, the waveguide terminating in a first waveguide end face, a first iris defined between the first waveguide end face and the first transformer end face; a second rectangular waveguide having a rectangular cross-section orthogonal to the cross-section of the first waveguide and a second waveguide end face and arranged with its longitudinal axis orthogonal to the first transformer side face with a long side parallel to the first transformer end face so as to propagate microwave energy having a polarisation plane orthogonal to the polarisation plane of energy in the first waveguide, and a second iris defined between the second waveguide end face and the transformer side face.

Embodiments of the invention will now be described by way of non-limiting example only, with reference to the accompanying drawings in which:

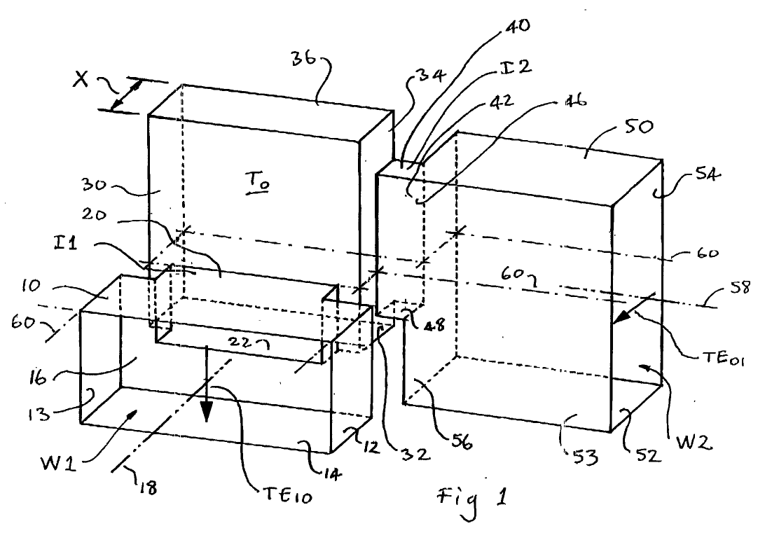

FIG. 1 shows a first embodiment of the invention;

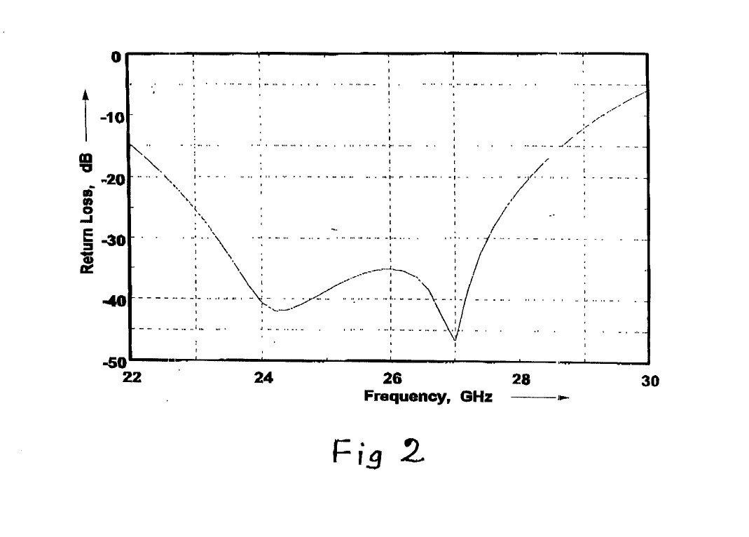

FIG. 2 shows a graph of the computed return loss as a function of a frequency of the first embodiment;

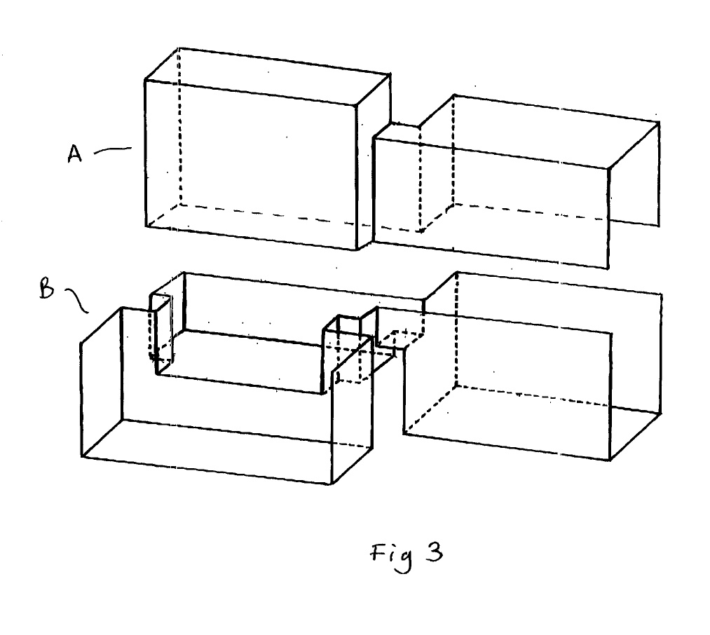

FIG. 3 shows the arrangement of FIG. 1 separated into two-part form along a possible plane of separation;

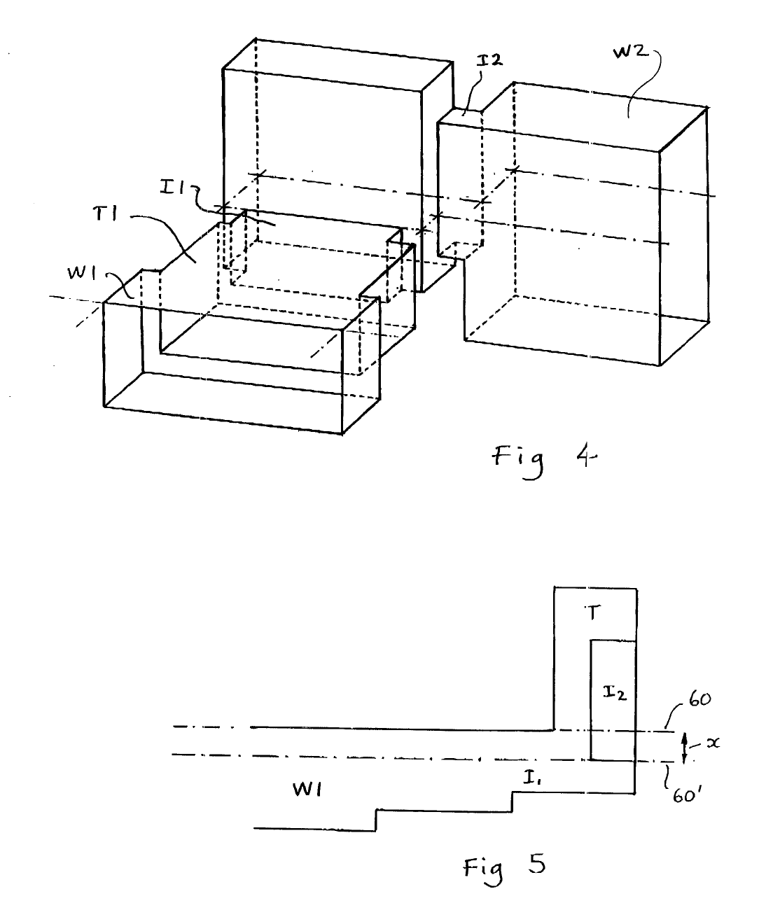

FIG. 4 shows a second embodiment to the invention,

FIG. 5 illustrates a range of possible planes of separation for FIGS. 1 and 4; and

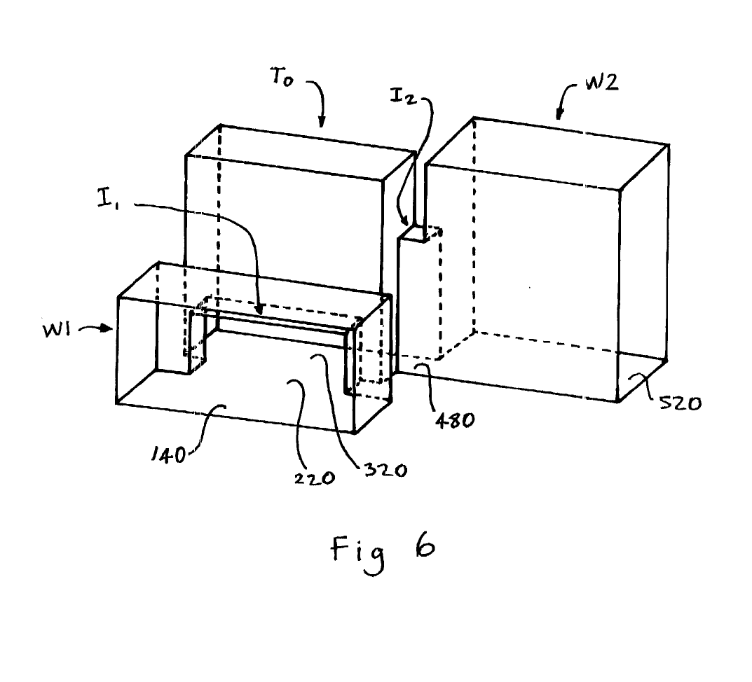

FIG. 6 shows a third embodiment of the invention.

FIG. 1 shows an isometric view of the internal walls of a twist transformation structure which can be fabricated in solid metal. The exterior of the structure and coupling flanges etc. have been omitted for clarity.

A first port consists of a standard rectangular waveguide section WI having long sidewalls 10, 14 and short sidewalls 12, 13. Waveguide W1 is coupled via a first iris I1 to a front side wall 30 of a central dual-mode transformer section Tₒ. In this embodiment an upper surface 20 of iris I1 forms a continuation of the upper surface of the long sidewall 10 of waveguide W1. The lower surface 22 of iris Ii forms a continuation of the lower surface 32 of the transformer Tₒ. A second port consisting of a second standard rectangular waveguide section W2 having lond sidewalls 50, 52 and short sidewalls 53, 54 is coupled via a second iris I2 to a side wall 34 of transformer section To. In this embodiment a first lateral surface 42 of iris I2 forms a continuation of sidewall 53 of waveguide W2. A second lateral surface 46 of iris 12 forms a continuation of a rear surface 36 of the is transformer section Tₒ.

Viewed from the first waveguide section W1, the transformer section Tₒ has an almost square cross-sectional area and a length X measured in the direction of the axis of W1 of about a quarter wavelength of the centre frequency of the bandwidth of intended operation. The square configuration means that the central transformer section Tₒ is capable of supporting both TE₁₀ and TE₀₁ modes.

In operation, a TE₁₀ microwave signal propagated in W1 passes through the first iris I1 and into the transformer section Tₒ where it excites TE₁₀ and TE₀₁ modes. The TE₀₁ mode within the transformer Tₒ couples via the second iris I2 into the second waveguide W2 where it excites a TE₀₁ mode (referenced to co-ordinate system of W1). It can be seen that, with reference to the vertical axis, waveguide W2 is rotated 90° with respect to waveguide W1 and hence, with respect to the vertical axis, the polarisation direction of microwave energy in W2 is orthogonal to the polarisation direction of microwave energy in W1. As can be seen from FIG. 2, the two discontinuities presented by irises I1 and I2 result in a frequency characteristic having two return loss zeros. These two zeros assist in the attainment of a, relatively wide useful bandwidth.

The configuration described above is particularly advantageous in that it allows manufacture in two halves which are mated together at a planar mating surface. In FIG. 1 the location of a particularly advantageous surface is shown by chained dashed lines 60. FIG. 3 shows the arrangement of FIG. 1 separated into an upper part A and a lower part B by the plane defined by chained dashed lines 60 of FIG. 1. It can be seen that all surfaces of upper part A are visible from below and all surfaces of lower part B are visible from above. The skilled person will appreciate that each half can therefore be easily and economically manufactured by casting or milling, since neither includes any undercut or hidden regions.

A second embodiment, shown in FIG. 4, differs from the first embodiment in that it includes a quarter wavelength transformer T1 in series with the first waveguide W1 and of the first iris I1, Transformer T1 provides an additional zero in the frequency response which allows a greater band width (about 20%) to be achieved compared with the first embodiment. Transformer T1 is preferably arranged with its upper face in the same plane as the upper faces of the waveguide W1 and the first iris I1. This facilitates manufacturing in two halves defined by the chained dashed lines as in the first embodiment.

In a modification of FIG. 4, not shown, a second transformer may be arranged in series between the second iris I2 and at the second waveguide W2 in addition to, or in place of, the first transformer. The provision of a second transformer in addition to the first transformer providers a further zero, allowing an even wider band width to be obtained.

While the parting lines 60 between upper and lower halves have been described as coincident with the upper surface of waveguide W1, this is not essential. As can be seen from FIG. 5 by choosing a parting line anywhere in zone x defined between planes 60 and 60′ neither half will have any hidden or overhanging areas. However, for ease of manufacture, a parting line on plane 60 is preferred. A plane other than 60 may be useful if it is desired to provide a transformer or iris whose upper surface is not coincident with the upper surface of waveguide W1, for example, so as to accommodate the relative spatial axes of waveguides W1 and W2 with other waveguides whose spatial positions are predetermined. The design freedom provided by offsetting the irises and transformers is particularly advantageous in integrated waveguide assemblies where prior art twist are unsuitable due to lack of space or high manufacturing cost. Rather than other components having to be designed to mate with the waveguide twist, the waveguide twist can be designed to mate with the other components.

Thus, while FIG. 1 shows the upper short edge of iris I2 coplanar with the upper surface 50 of the second waveguide W2, it would be possible to vertically and/or laterally offset the second waveguide W2 so that the second iris 12 were located at a different part of end surface 56.

Conversely, where a twist is to be used in a location where there is some freedom in the positioning of waveguides W1 and W2, it is possible to utilise an arrangement in which all the complex machining or casting is carried out on only one of the two parts, the mating surface of the other part consisting of a planar surface.

An example of such an arrangement is shown in FIG. 6, where lower surface 140 of the first waveguide W1, 220 of the first iris I1, 320 of the transformer section To, 480 of second iris I2, and 520 of second waveguide W2, all lie in the same plane. It can be seen that, when manufactured in two parts, the upper part can be manufactured by simple machining, since all parts are visible from below, and the lower part is a simple planar surface. N this; embodiment, while the axes of the waveguides W1, W2 are fixed in a vertical sense, a certain amount of choice of lateral position of both W1 and W2 is possible.

1. A waveguide twist providing orthogonal rotation of both direction and polarisation, comprising:
a transformer section (Tₒ) having a generally square cross-section and having a first transformer end face (30) and a side face (34),
a first rectangular waveguide (W1) arranged to propagate microwave energy having a first polarisation (TE₁₀) and whose axis 18 is arranged orthogonal to the first transformer end face (30) with a short side (12, 13) parallel to the side face (34), the waveguide terminating in a first waveguide end face (16),
a first iris (I1) defined between the first waveguide end face (16) and the first transformer end face (30),
a second rectangular waveguide (W2) having a rectangular cross-section orthogonal to the cross-section of the first waveguide (W1) and a second waveguide end face (56) and arranged with its longitudinal axis (58) orthogonal to the first transformer side face (34) with a long side (53, 54) parallel to the first transformer end face (30) so as to propagate microwave energy having a polarisation (TE₀₁) orthogonal to the polarisation in the first waveguide (W1), and
a second iris (I2) defined between the second waveguide end face (56) and the transformer side face (34).

2. A microwave twist as claimed in claim 1 in which the first iris (I1) is vertically offset towards a long side (10, 14) of the first waveguide (W1) and towards the bottom of the front face (30) of the transformer section (T₀).

3. A microwave twist as claimed in claim 2 in which a long surface (20; 220) of the first iris (I1) is coincident with a long sidewall (10; 140) of the first waveguide.

4. A microwave twist according to claim 2 or 3 in which the lower surface (22; 220) of the first iris (I1) is coincident with the bottom face (32; 320) of the transformer (T₀).

5. A microwave transformer as claimed in any preceding claim, in which the second iris (I2) is laterally offset towards a long sidewall (53) of the second waveguide (W2).

6. A microwave transformer as claimed in claim 5 in which a first surface (42) of the second iris (I2) is coincident with a side wall (53) of the second waveguide (W2).

7. A microwave transformer as claimed in claim 5 or 6 in which the second iris (I2) is vertically offset towards a short side wall (50, 52) of the second waveguide (W2).

8. A microwave transformer as claimed in claim 7 in which a short surface (40) of the second iris (I2) is coincident with a short side wall (50, 52) of the second waveguide (W2).

9. A microwave transformer as claimed in any one of claims 5 to 8 in which a second surface (46) of the second iris (I2) is coincident with a second end face (36) of the transformer section (To).

10. A waveguide twist as claimed in any preceding claim, further comprising a first transformer (T1) arranged between the first waveguide (W1) and the first iris (I1).

11. A waveguide twist as claimed in any preceding claim, further comprising a second transformer arranged between the second waveguide (W2) and the second iris (I2).

12. A waveguide twist as claimed in any preceeding claim, in which a long sidewall (140) of the first waveguide (W1), a long surface (220) of the first iris, the bottom surface (320) of the transformer section (To), and a short surface (480) of the second waveguide (W2) lie in the same plane.
